(19) United States
(12) Patent Application Publication
(10) Pub. No.: US 2010/0114767 A1
(43) Pub. Date: May 6, 2010

(54) APPARATUS AND METHODS FOR CARD DISPENSING

(75) Inventors: Chuan Bin Lin, Richardson, TX (US); Tim Byrd, Charlotte, NC (US); Rhonna J. Clark, Charlotte, NC (US); Helen elaine Sarris, Burlington, NJ (US); Dan Shnowske, Waxahachie, TX (US); William S. Treadwell, Charlotte, NC (US); Mian Zhou, Dallas, TX (US)

Correspondence Address: Weiss & Arons, LLP, 1540 Route 202, Suite 8, Pomona, NY, 10970, US

(73) Assignee: Bank of America Corp., Charlotte, NC (US)

(21) Appl. No.: 12/262,493

(22) Filed: Oct. 31, 2008

(51) Int. Cl. G06Q 40/00; G06F 3/12

(52) U.S. Cl. 705/41; 705/35; 358/1.15

(57) ABSTRACT

Apparatus and methods for providing a card that has a stored value. The apparatus and methods may involve offering the card to a customer, applying branding information to the card, charging a customer account for the value, and dispensing the card. The stored value card may be provided by a machine to a customer. The machine may be a financial institution automated teller machine (ATM). The ATM may transmit instructions to transfer funds from the customer's to one or more of the financial institution's retail partners. The ATM may apply visual information to the card. The visual information may include branding information, a message or any other suitable information.

### FIELD OF TECHNOLOGY

Aspects of the disclosure relate to providing stored value cards. In particular, the disclosure relates to dispensing such cards from a machine.

### BACKGROUND

A merchant often promotes sales of goods and services by providing a consumer with a voucher that may be exchanged for the goods and services. The voucher may be purchased by the consumer and used by the consumer to obtain goods and/or services. The voucher may be purchased by the consumer and given to a different consumer as a gift. The voucher may have a monetary value that may be used in connection with the purchase of goods and services.

In some instances, the monetary value is provided by the merchant, as in the case of a coupon. In some instances, the monetary value may correspond to funds provided by the consumer, as in the case of a gift certificate. The selected value may be used in a single transaction or, gradually, over the course of more than one transaction.

The purchase of vouchers typically requires engaging in a transaction with the merchant, whether at a brick-and-mortar facility or at the merchant's web site. Consumers desire increasingly convenient options for purchasing vouchers. For example, during holiday seasons the customers may be required to wait in long lines at a retail stores at different locations.

It would be desirable, therefore, to provide apparatus and methods of providing a voucher to a consumer from a machine.

### SUMMARY OF THE INVENTION

It is an object of the invention to provide apparatus and methods for developing a machine which enables a card purchase. Apparatus and methods for providing the card are therefore provided. The apparatus and methods may involve offering the card to a customer, applying branding information to the card, charging a customer account for a value, and dispensing the card.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of apparatus that may be used in connection with the principles of the invention;

FIG. 2 shows another schematic diagram of apparatus that may be used in connection with the principles of the invention;

FIG. 3 shows an illustrative process in accordance with the principles of the invention; and

FIGS. 4A and 4B show another illustrative process in accordance with the principles of the invention.

### DETAILED DESCRIPTION OF THE INVENTION

Apparatus and methods for providing a voucher from a machine are provided. The voucher may take one of many different forms, such as a coupon, a gift certificate, a special offer and a stored value card. The apparatus and methods may involve offering the card to a customer, applying branding information to the card, charging a customer account for the value, and dispensing the card.

The card may be a stored value card, a gift card, a gift certificate, a temporary credit card, a check card, or any other type of card with a value for a transaction with a vendor.

The card may be used for purchasing one or more goods or services from one or more vendors. The customer may choose the vendor or a combination of different vendors. In some embodiments, the vendor may be pre-determined.

The value of the card may be chosen, or selected by the customer during a transaction. The value of the card may be restricted to a minimum value or a maximum value. In some embodiments, the card may have an expiration date after which it is no longer valid for a transaction.

The card may be pre-printed, modified in the machine, branded in the machine, and/or activated in, or by, the machine, in one or more chosen and/or pre-determined ways.

The value of the card may be paid for by the customer using a bank card, a credit card, a debit card a cash card, a stored value card, cash, or any other suitable method of payment.

The card may be offered by a machine such as an automated teller machine (“ATM”), a banking machine, financial machine, or kiosk, or any other machine, which may or may not be automated, and which may print a card. The card may be offered via the Internet, a mobile device, or any other suitable customer interface which allows for a purchase. The card may be subsequently provided by the machine. In some embodiments, the card may be offered by a customer service associate at a brick-and-mortar institution. The associate may execute a transaction on behalf of the customer.

At the machine, a transaction module may charge the customer's account for the fee. The module may reimburse the vendor for all or part of the value. The machine may dispense the card to the customer. The customer may use the card for a future purchase of goods and/or services from the vendor.

The machine may include a customer interface. The customer interface may be used for the card purchase. The customer interface may have the capability to place orders for pickup/delivered products/services. Further information regarding the offering, purchasing, and/or charging of these products/services is set forth below.

In some embodiments, the branding information may be applied to the card at, or within, the machine. The branding information may identify the vendor, the supplier of the card, the value of the card, the owner of the machine, the user of the machine, or any other relevant information pertaining to the card, the vendor, the supplier and the customer.

In some embodiments, non-branding information, such as a printed message, symbol, or other suitable marking, may be applied to the card at, or within, the machine. The non-branding information may be pre-determined or may be selected by the customer.

The customer may be a commercial customer, small business, a mid-sized business, a large business, or any other type of organization or entity.

The machine may offer the card to the customer during a transaction via a banking or financial machine or a communication network interface. The transaction may be a transaction in which the customer withdraws funds from an account, transfers funds from one account to another, pays a bill, inquires about account information or any other suitable transaction.

In some embodiments, the customer may be offered the option of sending the card value to another individual. The other individual may be a customer. The other individual may be informed about the purchase of the card and may print the card at a machine. The sending customer may be offered an option to send an electronic message regarding the card, and/or an electronic version of the card, to the other individual via e-mail. The sending customer may be offered an option to send a message regarding the card to the other individual via postal mail.

The card-purchasing customer may or may not be charged for one, some, or all of the transactions outlined above.

The customer account to which the value of the card may be charged may be a commercial account, a small business account, a personal or consumer demand deposit account used for personal, business or any other type of account suitable for purchases.

The vendor may be charged a fee in connection with a transaction using the card. For example, the vendor may be charged a commission for a purchase of goods and/or services using the card.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

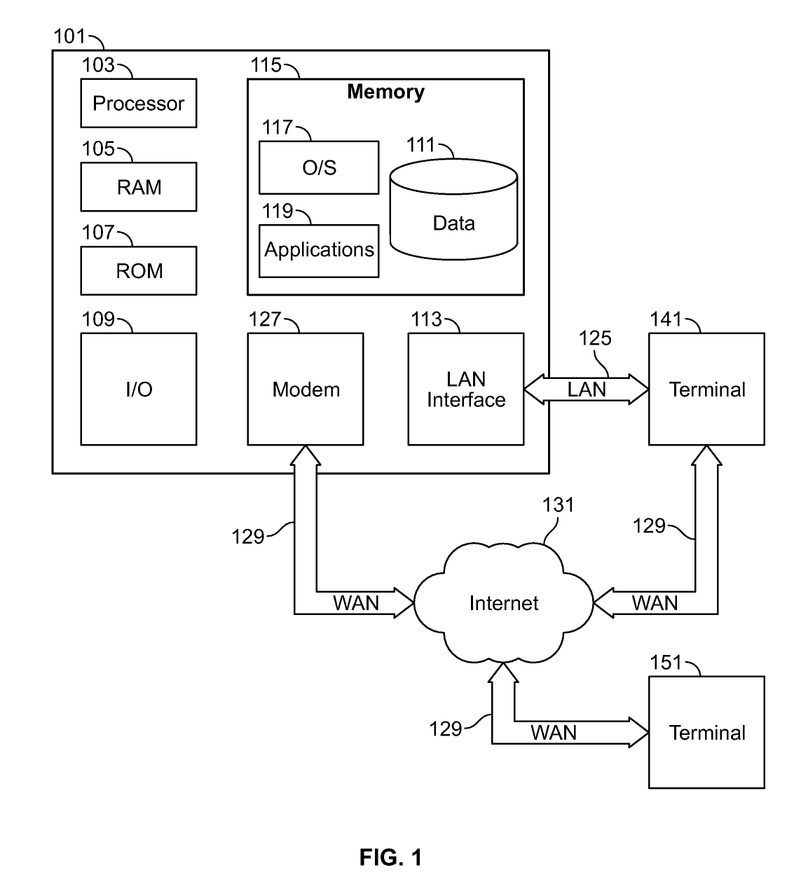

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 201 computer executable instructions may be embodied in hardware or firmware (not shown). As described in detail below, database 121 may provide storage for, customer transaction information, customer information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Customer information, including bank account information, customer selected information, customer transaction records, card information, card branding information, vendor information and other suitable information may be stored in memory 125.

One or more of applications 119 may include one or more algorithms that may be used to perform card purchasing, card sending, card branding and/or modifying, card printing, and any other suitable tasks related to purchasing a card.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

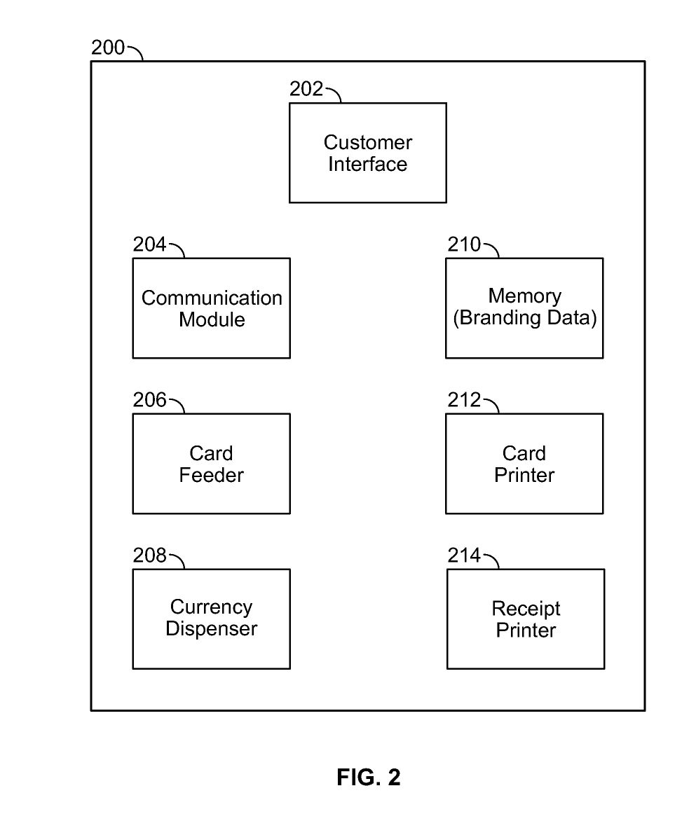

FIG. 2 is a block diagram that shows illustrative card dispensing machine 200. Machine 200 may include customer interface 202. Using customer interface 202, a user may provide input through a microphone, keypad, touch screen, and/or stylus. The interface may have graphic, audiovisual, video and/or audio output in order to interact with the user.

Machine 200 may include communication module 204. Communication module 204 may interface with an electronic communication network. Module 204 may exchange information regarding the user, the user's bank accounts, a transaction involving the purchase of a card, an individual on whose behalf the user purchases a card, vendors (e.g., retail partners) and any other suitable information. Card swiper 206 may receive the users' personal information, financial information, or other relevant information.

Currency dispenser 208 may dispense currency to the user in connection with one or more transactions at the machine. Memory branding files 210 may store information regarding the card, the branding, the modifying and dispensing of the card, the retail partner, the user's choices, transactions and/or specifications. Card printer 212 may print branding and/or message information on the card. Receipt printer 214 may print a receipt documenting some or all of the transactions executed by the user, and/or other information regarding the user and/or one or more account.

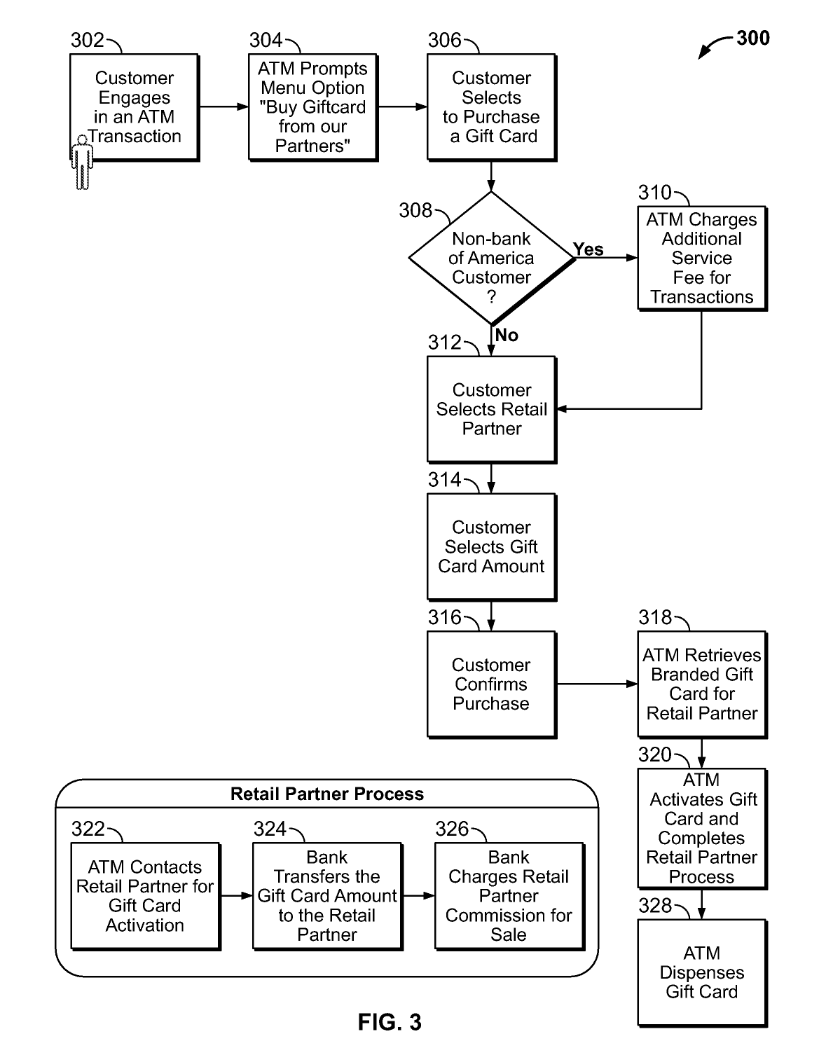

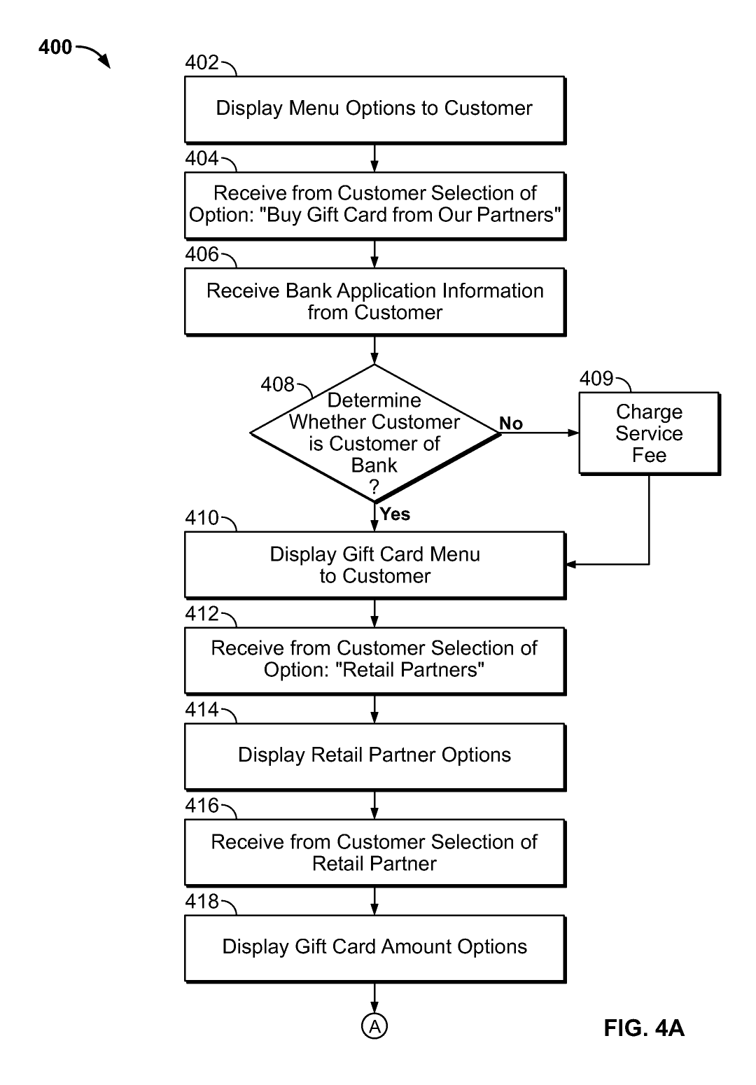

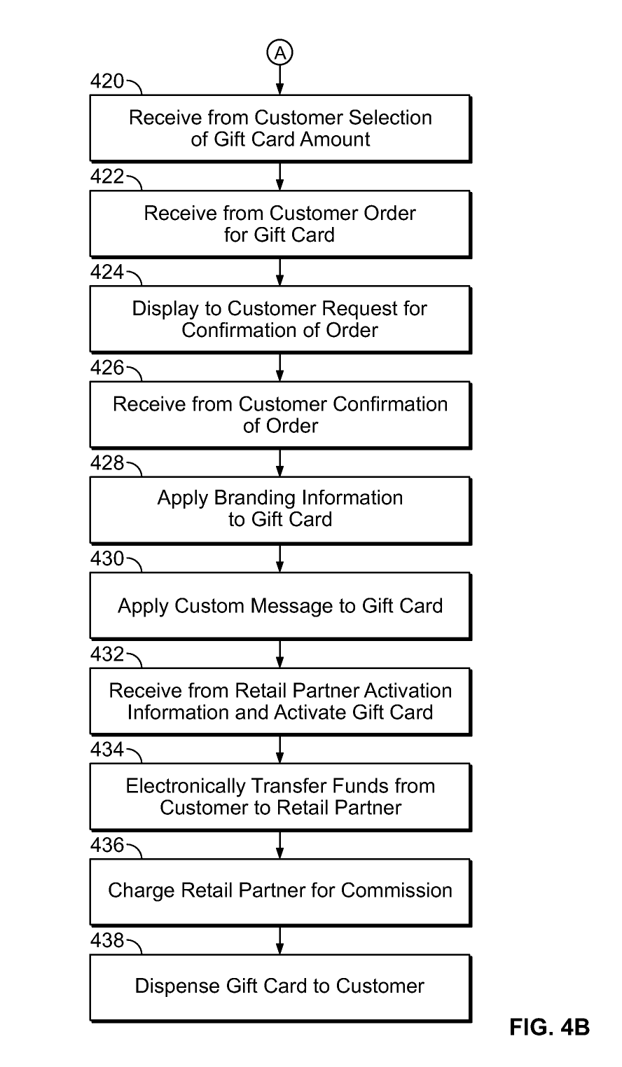

Processes in accordance with the principles of the invention may include one or more features of the processes illustrated in FIGS. 3-4. For the sake of illustration, the processes illustrated in FIGS. 3-4 will be described as being performed by a “system”. The “system” may include one or more of the features of the apparatus shown in FIGS. 1 and 2, one or more individuals and/or any other suitable device or approach. The “system” may be provided by an entity. The entity may be an individual, an organization or any other suitable entity.

FIG. 3 shows illustrative process 300 for purchasing a card at a machine, where the card is a gift card and the machine is an automated baking machine, as described above. Process 300 may be used when a customer desires to purchase a gift card from an automated banking machine. Process 300 may begin at step 302. At step 302, the customer may engage in an ATM transaction. At step 304, the ATM may offer the customer a “Buy Gift Card from our Partners” option. At step 306, the customer may select to purchase a gift card. At step 308, the customer may be asked if he is a customer of a bank associated with the banking machine. The customer may be a customer of the bank, or of a different bank.

If the customer is a customer of the bank associated with the banking machine, process 300 may continue with step 312. If the customer is not a customer of the bank, process 300 may continue at step 310. At step 310, the customer may be charged an additional service fee for the transactions. Process 300 may continue at step 312.

At step 312, the customer may select a retail partner from whom to purchase the gift card. At step 314, the customer may select a gift card amount. At step 316, the customer may confirm a purchase. At step 318, the machine may retrieve the gift card branded with a symbol of the retail partner, or printed with any other suitable information. At step 320, the automated machine may activate the gift card and complete a retail partner process described in connection with steps 322, 324 and 326.

At step 322, the automated machine may contact the retail partner to activate the gift card. In some embodiments, activation may involve receiving from the retail partner a code that matches a code that is present on a retail partner server (not shown). At step 324, the bank associated with the banking machine may transfer the gift card amount to the retail partner. At step 326, the bank may charge the retail partner a commission for the sale. In some embodiments, charging or settling the commission may be deferred until the customer purchases goods and/or services using the card.

Process 300 may now continue at step 328. At step 328, the machine may dispense the gift card to the customer.

FIGS. 4A and 4B shows illustrative process 400 for purchasing a card at a machine. Some of the features of process 400 may be similar to those features shown and described herein in connection with process 300 (see FIG. 3). Process 400 may include the application of visual information to a stored value card. The visual information may include one or of the following: branding information, a bank-customized message, a customer-customized message and any other suitable information.

In process 400, the card is exemplified as a gift card and the machine is exemplified as an banking machine. Process 400 may begin at step 402. At step 402, the customer may engage in an ATM transaction and see a display of menu options. At step 404, the customer may select a “Buy Gift Card from our Partners” option. At step 406, the customer may be asked if he is a customer of a bank associated with the banking machine. The customer may be a customer of the bank, or of a different bank.

If the customer is a customer of the bank associated with the banking machine, process 400 may continue with step 410. If the customer is not a customer of the bank, process 400 may continue at step 408. At step 408, the customer may be charged a service fee. Now process 400 may continue with step 410.

At step 410, a gift card menu may be displayed. At step 412, the customer may choose the “Retail Partners” option. At step 414, retail partner options may be displayed. At step 416, the customer may choose a retail partner. At step 418, gift card amount options may be displayed. At step 420, the customer may select a gift card amount. At step 422, the customer may select to purchase the gift card. At step 424, a confirmation request may be displayed. At step 426, the customer may confirm his purchase. Step 428 is one of several steps that may be initiated or controlled by an automatic device. At step 428, the machine may apply branding information to the gift card. The branding information may be applied using a printer, for example. At step 430, the machine may apply a customized message to the gift card. The customized message may be provided by the customer at the machine, for example.

In embodiments in which the customer purchases the card via a mobile device or another Internet-based device, the customer may provide the message at an appropriate client device. In some embodiments, the customer may provide graphic or photographic data for printing on the card. The graphic or photographic data may be provided via a user interface. The user interface may be in communication with memory for storing the graphic or photographic data.

At step 432, the retail partner may be contacted for activation information. The card may then be activated. At step 434, a transaction transferring the gift card amount from the customer to the retail partner may occur. At step 436, the retail partner may be charged commission for the sale, completing the transaction. At step 438, the gift card is dispensed to the customer.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for providing a card with a value for a transaction have been provided. Persons skilled in the art will appreciate that the present invention can be practiced by other than the described embodiments, which are presented for purposes of illustration rather than of limitation. The present invention is limited only by the claims that follow.

What is claimed is:

1. A method for providing a card at a machine, the card having a value for a transaction with a vendor, the method comprising:
offering the card to a customer;
applying branding information to the card; and
dispensing the card.

2. The method of claim 1 wherein the value is pre-determined.

3. The method of claim 1 further comprising activating the card with the selected value.

4. The method of claim 1 wherein the offering comprises offering a temporary credit card to the customer.

5. The method of claim 1 further comprising collecting a fee from the vendor, the fee corresponding to a service charge for the dispensing of the card.

6. The method of claim 1 wherein:
the dispensing comprises using an automated teller machine of a banking institution to dispense the card; and
the collection of the fee from the vendor comprises collecting the fee from a retail partner.

7. The method of claim 1 further comprising receiving from the customer information identifying another customer that is designated to receive the card; wherein the dispensing comprises dispensing the card to the alerted customer that is designated to receive the card.

8. The method of claim 1 wherein the branding is applied within the machine.

9. The method of claim 1 further comprising printing the branding information on a surface of the card.

10. A method for providing a card at a machine, the card having a value for a transaction with a vendor, the method comprising:
offering the card to a customer;
charging a customer account for the value; and
dispensing the card.

11. The method of claim 10 wherein the value is pre-determined.

12. The method of claim 10 wherein the card is pre-printed.

13. The method of claim 10 further comprising branding the card.

14. The method of claim 10 further comprising receiving from the customer a selection of the value, and encoding the card with the value.

15. The method of claim 10 wherein the offering comprises offering a temporary credit card to the customer.

16. The method of claim 10 further comprising collecting a fee from the vendor, the fee corresponding to a service charge for the dispensing of the card.

17. The method of claim 16 wherein the collecting comprises collecting the fee from a retail partner.

18. The method of claim 10 further comprising receiving from the customer information identifying another customer that is designated to receive the card; wherein the dispensing comprises dispensing the card to the alerted customer that is designated to receive the card.

19. An apparatus for dispensing a card, for a transaction with a vendor, the apparatus comprising:
a processor configured to receive from a user information identifying the vendor;
a printer configured to apply branding information to the card, the branding information corresponding to the vendor; and
a card dispenser configured to provide the card to the user.

20. The apparatus of claim 19 further comprising a memory module in communication with the processor, the memory module being configured to retain the branding information and communicate the branding information to the processor.

21. The apparatus of claim 19 further comprising a communication module in communication with the processor and the printer, the communication module being configured to:
receive the branding information from an electronic communication network; and
provide the branding information to the printer for application to the card.

22. One or more computer-readable media storing computer-executable instructions which, when executed by a processor on a computer system, perform a method for providing a card at a machine, the card having a value for a transaction with a vendor, the method comprising:
offering the card to a customer;
applying branding information to the card; and
dispensing the card.

23. The media of claim 22 wherein, in the method, the offering comprises offering a temporary credit card to the customer.

24. The media of claim 22 wherein the method further comprises collecting a fee from the vendor, the fee corresponding to a service charge for the dispensing of the card.

25. The media of claim 22 wherein, in the method:
the dispensing comprises using an automated teller machine of a banking institution to dispense the card; and
the collection of the fee from the vendor comprises collecting the fee from a retail partner.

26. The media of claim 22, wherein the method further comprises:
receiving from the customer information identifying another customer that is designated to receive the card;
wherein the dispensing comprises dispensing the card to the alerted customer that is designated to receive the card.

27. The media of claim 22 wherein, in the method, the branding information is applied within the machine.

28. The media of claim 22 wherein the method further comprises printing the branding information on a surface of the card.
